(19) United States
(12) Patent Application Publication
(10) Pub. No.: US 2018/0331994 A1
(43) Pub. Date: Nov. 15, 2018

(54) ELECTRONIC MAIL SENDER AND RECIPIENT CORRELATION DETERMINATION SYSTEM

(71) Applicant: Konica Minolta, Inc., Tokyo (JP)

(72) Inventor: Kazuaki Kanai, Tokyo (JP)

(73) Assignee: Konica Minolta, Inc., Tokyo (JP)

(21) Appl. No.: 15/975,940

(22) Filed: May 10, 2018

(30) Foreign Application Priority Data
May 12, 2017 (JP) 2017-095881

(51) Int. Cl. H04L 12/58

(52) U.S. Cl. CPC H04L 51/30; H04L 51/28; H04L 51/04

(57) ABSTRACT

An electronic mail sender and recipient correlation determination system includes: a hardware processor that determines that a first user of a first electronic mail address that is designated as a destination of a sending electronic mail that has been sent and a second user of a second electronic mail address as a sending source of a reply electronic mail that has been sent are identical. The first user and the second user are identical when the hardware processor determines that values indicating identification information that is included in and specific to the sending electronic mail match specific identification information that is included in an electronic mail of a reply source of the reply electronic mail. The reply electronic email is sent, after the sending electronic mail, with a sending source of the sending electronic mail as a destination

The entire disclosure of Japanese patent Application No. 2017-095881, filed on May 12, 2017, is incorporated herein by reference in its entirety.

### BACKGROUND

### Technological Field

The present invention relates to an electronic mail sender and recipient correlation determination system that determines a correlation between senders and recipients of electronic mails and prepares a correlation map on the basis of sent and received electronic mails.

### Description of the Related Art

In general, electronic mails have been widely used to exchange a variety of information with processing of business. In exchange of electronic mails, it is very important to ascertain a relationship with a company or a person for each address which is used. However, it takes much labor and time to ascertain all electronic mails stored in a computer and to find out a relationship between senders and recipients. This is because a user checks and analyzes the electronic mails one by one with naked eyes.

For example, JP 2006-338448 A discloses a method of supporting efficient ascertainment of a relationship between senders and recipients by preparing a correlation diagram between senders and recipients on the basis of information of electronic mails from the senders to the recipients.

FIG. 16 is a diagram illustrating an example of a correlation diagram which is prepared by the method described in JP 2006-338448 A. FIG. 16 illustrates a personal correlation diagram in which users are defined as terminals and users having exchanged electronic mails with each other are connected by segments. FIG. 18 illustrates a person correlation diagram of six users (Users A to F). By displaying the correlation diagram illustrated in FIG. 18, it is possible to easily ascertain a relationship for each user.

Here, one user may use two or more electronic mail addresses. Examples thereof include a case in which an electronic mail address of an old name is used as a mail alias of an electronic mail address of a new name and a case in which electronic mail addresses are partitively used in a company and at home.

In the method described in JP 2006-338448 A, when one user uses two or more electronic mail addresses as described above, the electronic mail addresses are different from each other and thus it is recognized that different users are present for the electronic mail addresses. FIG. 19 illustrates a correlation diagram which is prepared when User B exchanges electronic mails with User A using two different electronic mail addresses (Address 1 (tanaka@xyz.example) and Address 2 (yuko@xyz.example)).

In FIG. 19, the user using Address 1 and the user using Address 2 are recognized to be different users. In this way, when the same user uses a plurality of electronic mail addresses, users of the electronic mail addresses are recognized to be different users and thus a correlation between users cannot be accurately recognized.

Identification of object persons and manual correction to a single person are currently performed, but since the correction requires time, there is demand for a method of enabling correct recognition of a correlation for each user in this case.

### SUMMARY

One or more embodiments of the present invention provide an electronic mail sender and recipient correlation determination system that can accurately recognize a correlation between senders and recipients of electronic mails even when one user uses a plurality of electronic mail addresses.

In one or more embodiments of the present invention, an electronic mail sender and recipient correlation determination system comprises: a hardware processor that determines that a user of an electronic mail address which is designated as a destination of a sending electronic mail which has been sent and a user of an electronic mail address as a sending source of a reply electronic mail which has been sent are an identical user when it has been recognized that values indicating identification information which is included in the sending electronic mail and which is specific to the sending electronic mail and specific identification information which is included in an electronic mail of a reply source included in the reply electronic mail which is sent after the sending electronic mail with a sending source of the sending electronic mail as a destination match each other.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an electronic mail sender and recipient correlation determination system according to one or more embodiments of the present invention;

FIG. 2 is a block diagram schematically illustrating a configuration of a determination server according to one or more embodiments of the present invention;

FIG. 3 is a diagram illustrating an example of fields which are included in a mail header of an electronic mail;

FIG. 4 is a diagram schematically illustrating a routine until a correlation diagram is prepared in the electronic mail sender and recipient correlation determination system;

FIG. 5 is a diagram illustrating an example of a case in which a first condition is satisfied;

FIG. 6 is a flowchart illustrating an identical user determining process of inspecting whether the first condition is satisfied;

FIG. 7 is a flowchart illustrating a routine subsequent to the identical user determining process illustrated in FIG. 6;

FIG. 8 is a diagram illustrating a state in which an inquiry about whether to display electronic mail addresses on the same terminal is transmitted when sending/receiving data is imported from a manager terminal manually one by one;

FIG. 9 is a diagram illustrating a state in which an inquiry about whether to display electronic mail addresses on the same terminal is transmitted by an electronic mail when sending/receiving data is gathered and imported;

FIG. 10 is a diagram illustrating a state in which an inquiry about whether to display electronic mail addresses on the same terminal is transmitted on a browser when a correlation diagram display request has been received;

FIG. 11 is a flowchart illustrating a routine which is performed until a correlation diagram is displayed after the correlation diagram display request has been received;

FIG. 12 is a diagram illustrating a display example of a correlation diagram;

FIG. 13 is a diagram illustrating a state in which an inquiry about whether to gather and display electronic mail addresses of a certain destination at the time of display of a correlation diagram when there are a plurality of destinations of a sending electronic mail;

FIG. 14 is a diagram illustrating a state in which there are a plurality of reply electronic mails satisfying a first condition in response to a sending electronic mail;

FIG. 15 is a diagram illustrating an example in which a second condition is satisfied;

FIG. 16 is a diagram illustrating an example in which a third condition is satisfied;

FIG. 17 is a diagram illustrating an example in which there are a plurality of reply electronic mails satisfying the first condition in response to a sending electronic mail and users of electronic mail addresses as sending sources thereof are identical;

FIG. 18 is a diagram illustrating an example of a correlation diagram between users having sent and received electronic mails; and

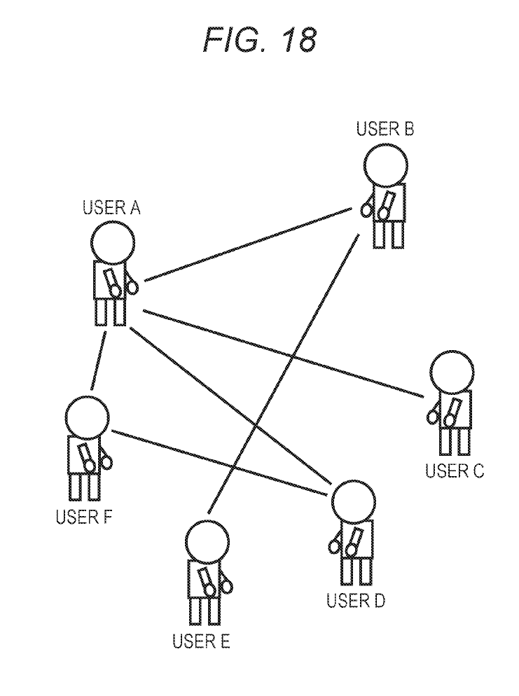

FIG. 19 is a diagram illustrating an example in which one user uses a plurality of electronic mail addresses.

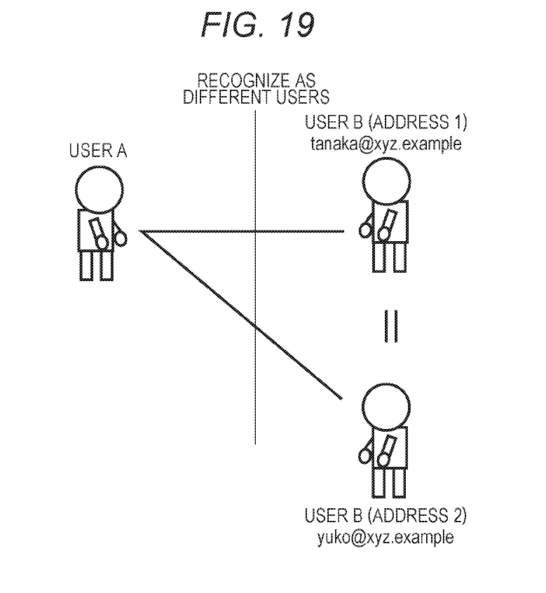

### DETAILED DESCRIPTION

Hereinafter, one or more embodiments of the present invention will be described with reference to the drawings. However, the scope of the invention is not limited to the disclosed embodiments.

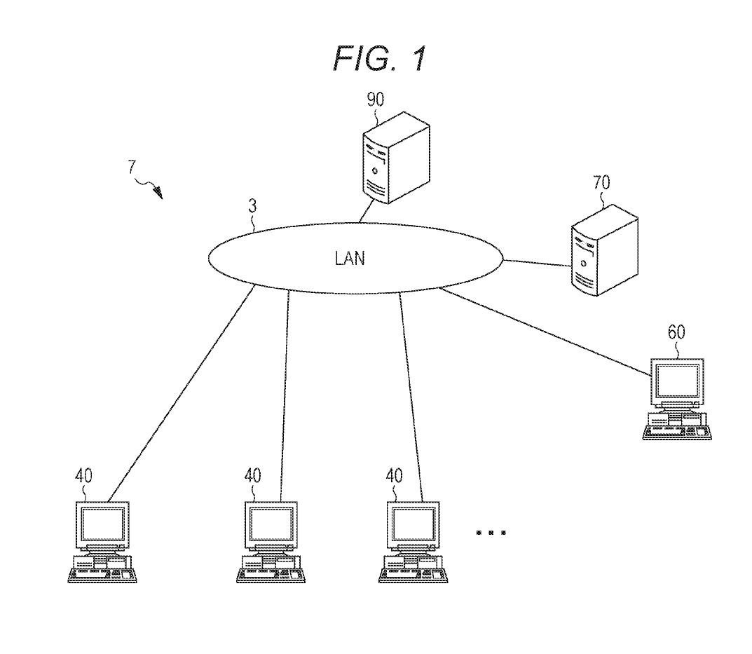

FIG. 1 illustrates an electronic mail sender and recipient correlation determination system 7 according to one or more embodiments of the present invention. The electronic mail sender and recipient correlation determination system 7 has a configuration in which a determination server 70 that serves as a determiner, a plurality of PC terminals 40, a manager terminal 60, and a mail server 90 are communicatively connected via a network such as a local area network (LAN) 3.

Each PC terminal 40 is a so-called desktop PC terminal including a mouse or a keyboard, a display part such as a display, and an operation and can send and receive an electronic mail via a mailer. In one or more embodiments of the invention, an electronic mail sent from the PC terminal 40 can be sent to a destination which is designated in the electronic mail via the mail server 90. The PC terminal 40 can access the determination server 70 via a browser and open a correlation diagram which will be described later and which is prepared by the determination server 70.

The mail server 90 serves to receive an electronic mail sent from the PC terminals 40 or the manager terminal 60 and to send the electronic mail to a destination which is designated in the electronic mail. The mail server 90 stores sending/receiving data of the sent/received electronic mail.

The manager terminal 60 is the same desktop PC terminal as the PC terminals 40. The manager terminal 60 can instruct operation of the determination server 70 or import an electronic mail in addition to functions which can be performed by the PC terminal 40. For example, the determination server 70 may be instructed to receive sending/receiving data of an electronic mail from the mail server 90, a time at which the reception is performed is set, or sending/receiving data of an electronic mail may be acquired from the mailers of the PC terminals 40 and the sending/receiving data may be directly imported to the determination server 70.

The determination server 70 acquires sending/receiving data of an electronic mail and determines whether users of one electronic mail address which is used in an electronic mail indicated by the sending/receiving data and another electronic mail address are an identical user on the basis of predetermined conditions. The predetermined conditions will be described later.

The determination server 70 prepares a correlation diagram which is expressed by a line segment connecting a terminal corresponding to an electronic mail address of a sending source of the acquired electronic mail and a terminal corresponding to an electronic mail address of a destination with the electronic mail addresses as terminals. The prepared correlation diagram is displayed on a terminal such as the PC terminal 40 in response to a request from the PC terminal 40 or the like. At this time, a plurality of electronic mail addresses of which users are determined to be an identical user are gathered and displayed on one terminal.

Accordingly, a user can easily ascertain a correlation between the electronic mail addresses used in the sent and received electronic mails by checking the correlation diagram. Even when one user uses a plurality of electronic mail addresses, the electronic mail addresses which are used by the one user are gathered and displayed on one terminal in the correlation diagram and thus it is also possible to easily ascertain a correlation between the users using the electronic mail addresses.

A configuration of the determination server 70 according to one or more embodiments of the present invention will be described below.

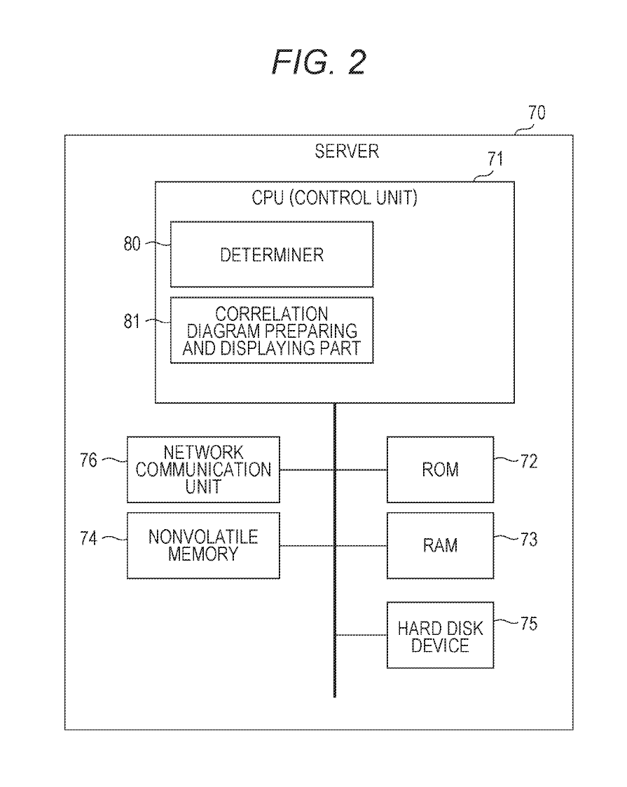

FIG. 2 is a block diagram schematically illustrating the configuration of the determination server 70 according to one or more embodiments of the present invention. The determination server 70 includes a central processing unit (CPU) 71 that comprehensively controls the operation of the determination server 70. A read only memory (ROM) 72, a random access memory (RAM) 73, a nonvolatile memory 74, a hard disk device 75, and a network communication unit 76 are connected to the CPU 71 including a microprocessor via a bus.

The CPU 71 executes an operating system (OS) program as a basis and executes middleware, application programs, or the like thereon. In one or more embodiments of the present invention, the CPU 71 serves as a determiner 80 and a correlation diagram preparing and displaying part 81.

The ROM 72 stores various programs, and the functions of the determination server 70 are embodied by causing the CPU 71 to perform various processes in accordance with the programs. The ROM 72 also stores a program for causing the CPU 71 to perform a series of controls of the determination server 70.

The RAM 73 is used as a work memory that temporarily stores various data when the CPU 71 performs processes on the basis of a program, or the like.

The nonvolatile memory 74 is a memory (a flash memory) in which stored details are not destroyed even when a power supply is turned off, and is used to store a variety of setting information or the like.

The hard disk device 75 is a nonvolatile storage device with a large capacity and stores an OS program, various application programs, data of electronic mails acquired from the mail server 90, an address book of electronic mail addresses, and the like. The hard disk device 75 serves as a storage of one or more embodiments of the present invention.

The network communication unit 76 serves to transmit and receive data to and from the PC terminal 40, the manager terminal 60, the mail server 90, and another external device via a network such as a LAN 3.

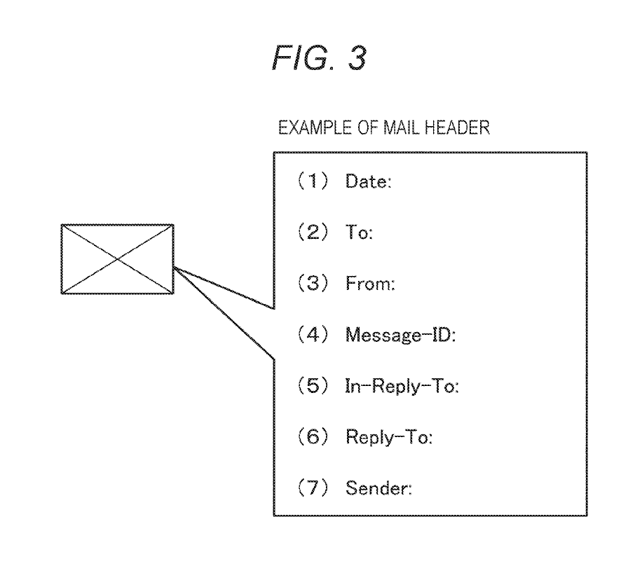

A mail header of an electronic mail will be described below. A mail header of an electronic mail includes a plurality of types of fields, and the fields indicate different information. FIG. 3 illustrates information which is indicated by each of a plurality of types of fields in the mail header used for an electronic mail.

In FIG. 3, examples of the field types in the mail header include the following fields of (1) to (7), which refer to the following information.

(1) Date:

The field of “Date:” indicates a time at which an electronic mail has been sent. Information such as day, date, month, year, time, and time zone are mainly described.

(2) To:

The field of “To:” indicates an electronic mail address of a destination which is designated by a sender. A plurality of electronic mail addresses can be designated, and electronic mail addresses are punctuated by “, (comma)” when a plurality of electronic mail addresses are designated.

(3) From:

In the field of “From:,” an electronic mail address of a sender of the electronic mail is designated. Similarly to the field of “To,” a plurality of electronic mail addresses can be designated.

(4) Message-ID:

The field of “Message-ID:” indicates an identifier specific to the electronic mail. The identifier is mainly constituted by combinations of an IP address, a domain name, and a computer name in addition to a date or a serial number.

(5) In-Reply-To:

The field of “In-Reply-To:” indicates to which electronic mail a reply is sent. Here, Message-ID of an electronic mail as a reply source is designated.

(6) Reply-To:

In the field of “Reply-To:,” an electronic mail address serving as a destination at the time of reply is designated. In general, when a reply to a received electronic mail is sent, the reply is sent to the electronic mail address displayed in “From:.” However, when an electronic mail address is designated in the field of “Reply-To:,” the reply is sent to the designated electronic mail address.

(7) Sender:

The field of “Sender:” indicates an electronic mail address of a sender of the electronic mail. Here, only one electronic mail address can be designated. When one electronic mail address is included in the field of “From:” in the mail header, the electronic mail address is designated as a sending source. However, when a plurality of electronic mail addresses are included in the field of “From:,” the electronic mail address included in the field of “Sender:” is identified as a sending source.

It is assumed that one of the fields of (1) to (7) is combined into and added to an electronic mail according to one or more embodiments of the present invention.

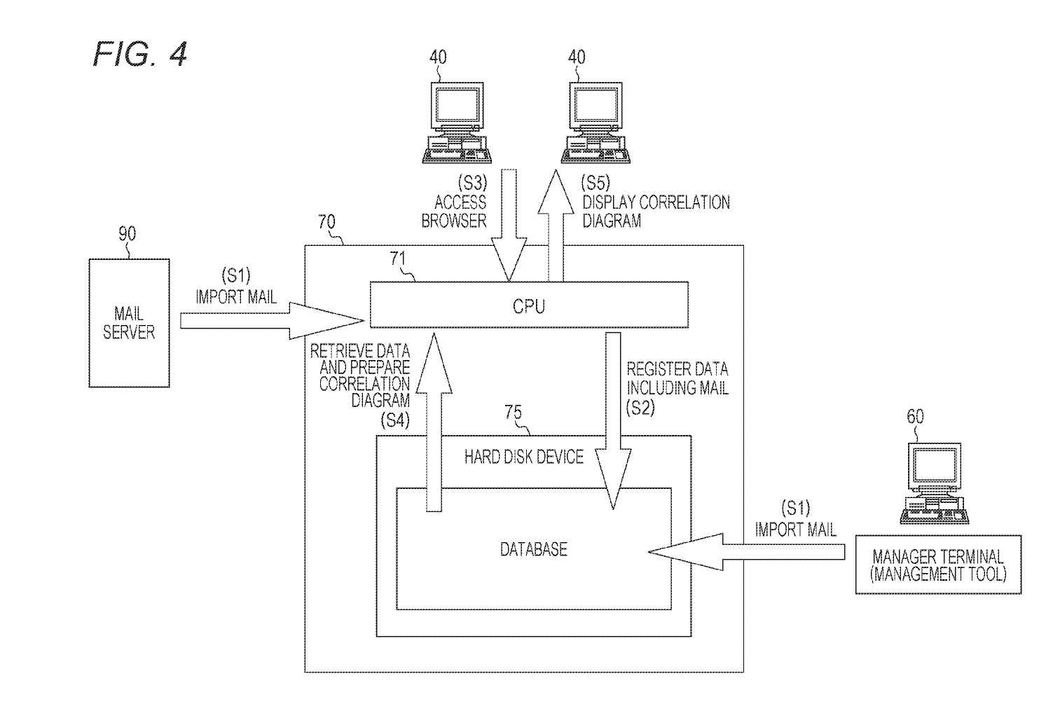

FIG. 4 schematically illustrates a routine until a correlation diagram is prepared and is displayed on the PC terminal 40 in the electronic mail sender and recipient correlation determination system 7. First, the determination server 70 acquires data of a sent and received electronic mail (S1). Examples of the acquisition method include a method of importing an electronic mail from the mail server 90 and a method of inputting data exported from the mailer of the PC terminal 40 or the like from the manager terminal 60. The data may be acquired using another method.

Then, the determination server 70 stores the acquired data of the electronic mail in the hard disk device 75 (S2). At the time of storage of the data, the determination server 70 determines whether a user of an electronic mail address of a sending source of a reply electronic mail and a user of another electronic mail address are an identical user using predetermined condition, and may register a database including the result thereof. Details of the predetermined conditions will be described later.

Then, when a correlation diagram display request is received from the PC terminal 40 through an access to a browser (S3), a correlation diagram which is expressed by a line segment connecting a terminal corresponding to an electronic mail address as a sending source of the electronic mail and a terminal corresponding to an electronic mail address as a destination with the electronic mail addresses as terminals is prepared on the basis of the information stored in the hard disk device 75 (S4).

Thereafter, the prepared correlation diagram is transmitted to the PC terminal 40 as a sending source of a display request and is displayed thereon (S5). At this time, a plurality of electronic mail addresses of which users have been determined to be an identical user are gathered and displayed on one terminal.

The predetermined conditions for determining whether users of one electronic mail address and another electronic mail address are an identical user will be described below. There are a plurality of predetermined conditions, and a first condition for determining whether a user of an electronic mail address as a sending source of a reply electronic mail and a user of another electronic mail address are the same user will be described below as an example of one or more embodiments.

The first condition is a condition corresponding to details of a mail header of an electronic mail. Specifically, the first condition is that values indicating identification information which is included in a sending electronic mail and which is specific to the sending electronic mail and specific identification information included in an electronic mail as a reply source included in a reply electronic mail which is sent after the sending electronic mail and sent with a sending source of the sending electronic mail as a destination match each other.

When the first condition is satisfied, the determination server 70 determines the user of the electronic mail address which is designated as a destination of the sending electronic mail and the user of the electronic mail address as the sending source of the reply electronic mail are the same user.

The identification information specific to a sending electronic mail in the first condition is information indicated by “Message-ID” which has been described above with reference to FIG. 3. The identification information included in the electronic mail of the reply source included in the reply electronic mail which is sent after the sending electronic mail and sent with the sending source of the sending electronic mail as a destination is information indicated by “In-Reply-To” which has been described above with reference to FIG. 3.

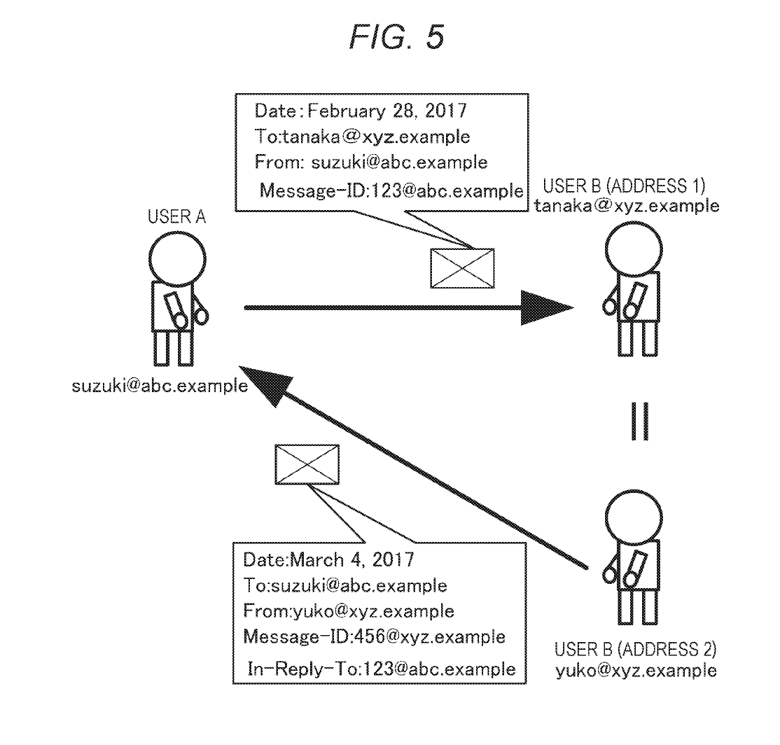

FIG. 5 illustrates a state in which it is determined whether a user of an electronic mail address as a sending source of a reply electronic mail and a user of an electronic mail address as a destination of the sending electronic mail are the same user using the first condition.

In FIG. 5, User A sends an electronic mail to Address 1 (tanaka@xyz.example) which is used by User B, and User B sends a reply to the electronic mail from Address 2 (yuko@xyz.example).

Information described in a mail header of the sending electronic mail transmitted by User A is as follows.

Date: Feb. 28, 2017

To: tanaka@xyz.example

From: suzuki@abc.example

Message-ID: 123@abc.example

Information described in a mail header of the reply electronic mail transmitted by User B is as follows.

Date: Mar. 4, 2017

To: suzuki@abc.example

From: yuko@xyz.example

Message-ID: 456@xyz.example

In-Reply-To: 123@abc.example

Since a sending date (Date) of the sending electronic mail is Feb. 28, 2017 and a sending date (Date) of the reply electronic mail is Mar. 4, 2017, the reply electronic mail is sent after the sending electronic mail.

The destination (To) in the reply electronic mail and the sending source (From) of the sending electronic mail are suzuki@abc.example and match each other.

The specific identification information (In-Reply-To) included in the electronic mail of a reply source of the reply electronic mail and the specific identifier (Message-ID) of the sending electronic mail are 123@abc.example and match each other.

Accordingly, since the reply electronic mail and the sending electronic mail illustrated in FIG. 5 satisfy the first condition, it is determined that the user of the electronic mail address (Address 2, yuko@xyz.example) as the sending source of the reply electronic mail and the user of the electronic mail address (Address 1, tanaka@xyz.example) as the destination of the sending electronic mail are the same user.

When the determination server 70 prepares a correlation diagram from the reply electronic mail and the sending electronic mail illustrated in FIG. 5 and displays the prepared correlation diagram on the PC terminal 40 or the like, Address 1 and Address 2 are gathered on one terminal, and the gathered terminal and the terminal of the electronic mail address (suzuki@abc.example) of User A are connected by a line segment. Accordingly, when the user of Address 1 is known to be User B, it is possible to easily ascertain that the user of Address 2 is also User B.

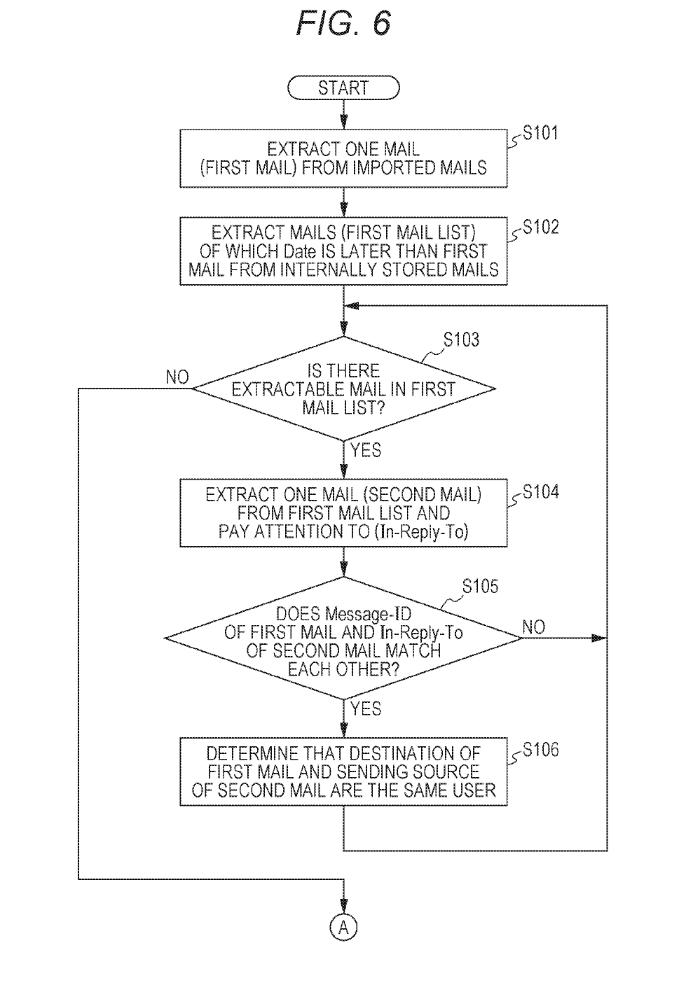

FIG. 6 illustrates a flow in which the determination server 70 determines whether a user of an electronic mail address as a destination of a sending electronic mail and a user of an electronic mail address as a sending source of a reply electronic mail are the same user on the basis of the first condition of imported electronic mails.

First, the determination server 70 extracts one electronic mail (a first mail) from the imported electronic mails (sending/receiving data) (step S101). Thereafter, electronic mails of which the date indicated by Date is after that of the first mail are extracted from the sending/receiving data which is stored in the determination server (step S102). Thereafter, a group of the extracted mails is referred to as a first mail list. In this case, when the first mail is a sending electronic mail and the first mail list is an electronic mail group which is candidates for a reply electronic mail to the first mail, it is checked whether the first condition is satisfied.

When an extractable electronic mail is present in the first mail list (YES in step S103), one electronic mail (a second mail) is extracted from the first mail list, and the value of In-Reply-To in the mail header thereof is ascertained (step S104).

When a value indicated by Message-ID of the first mail and a value indicated by In-Reply-To of the second mail match each other (YES in step S105), it is determined that a user of an electronic mail address as a destination of the first mail and a user of an electronic mail address as a sender of the second mail are the same user (step S106) and the routine continues to be performed from step S103.

When the value indicated by Message-ID of the first mail and the value indicated by In-Reply-To of the second mail are different from each other or when the field of In-Reply-To is not present in the mail header of the second mail or an effective value thereof is not registered (NO in step S105), the routine continues to be performed from step S103.

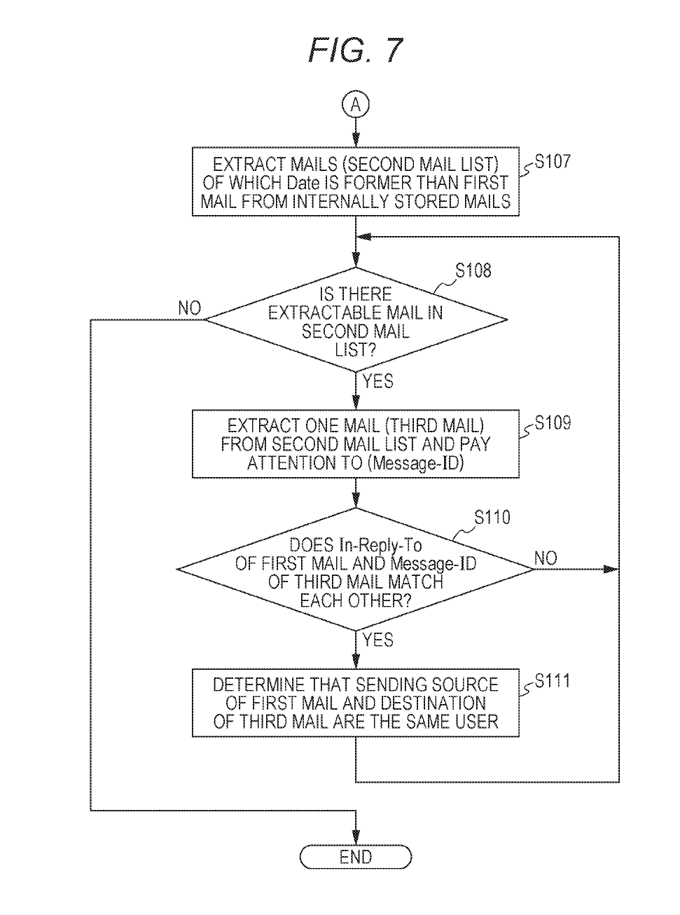

When there is no extractable (non-checked) electronic mail in the first mail list (NO in step S103), the routine transitions to step S107 of FIG. 7. FIG. 7 illustrates a routine subsequent to the routine illustrated in FIG. 6.

In step S107 of FIG. 7, mails of which the date indicated by Date is previous to that of the first mail are extracted from the sending/receiving data stored in the determination server. Thereafter, a group of the extracted mails is referred to as a second mail list. In this case, when the first mail is a reply electronic mail and the second mail list is an electronic mail group which is candidates for a sending electronic mail, it is checked whether the first condition is satisfied.

When an extractable electronic mail is present in the second mail list (YES in step S108), one electronic mail (a third mail) is extracted from the second mail list, and the value of Message-ID in the mail header thereof is ascertained (step S109).

When a value indicated by In-Reply-To of the first mail and a value indicated by Message-ID of the third mail match each other (YES in step S110), it is determined that a user of an electronic mail address as a sending source of the first mail and a user of an electronic mail address as a destination of the third mail are the same user (step S111) and the routine continues to be performed from step S108.

When the value indicated by In-Reply-To of the first mail and the value indicated by Message-ID of the third mail are different from each other or when the field of In-Reply-To is not present in the mail header of the first mail or an effective value thereof is not registered (NO in step S110), the routine continues to be performed from step S108.

When there is no extractable (non-checked) electronic mail in the second mail list (NO in step S108), the routine ends.

The determination server 70 stores a combination of electronic mail addresses of which the users are determined to be the same user in step S106 and step S111 in FIGS. 6 and 7.

In one or more embodiments of the invention, the identical user determining process described with reference to FIGS. 6 and 7 is performed at a time immediately before a correlation diagram is prepared in response to a correlation diagram display request or when sending/receiving data of an electronic mail is newly imported.

When the identical user determining process is performed immediately before a correlation diagram is prepared, the identical user determining process is repeatedly performed until all the electronic mails stored in the hard disk device 75 are handled as the first mail.

When the identical user determining process is performed when sending/receiving data of an electronic mail is newly imported, the imported electronic mail is handled as the first mail and the identical user determining process is performed. When a plurality of pieces of sending/receiving data are gathered and imported, the identical user determining process is repeatedly performed until the plurality of electronic mails are handled as the first mail.

In one or more embodiments of the invention, the determination server 70 inquires about whether a plurality of electronic mail addresses of which users have been determined to be the same user are gathered and displayed on one terminal (an inquiry about whether to display a plurality of electronic mail addresses on the same terminal), and gathers and displays the plurality of electronic mail addresses of which users have been determined to be the same user on one terminal at the time of displaying of a correlation diagram only when it has been instructed to gather and display the electronic mail addresses.

The inquiry about whether to display a plurality of electronic mail addresses on the same terminal is performed using different methods depending on the time at which the identical user determining process is performed.

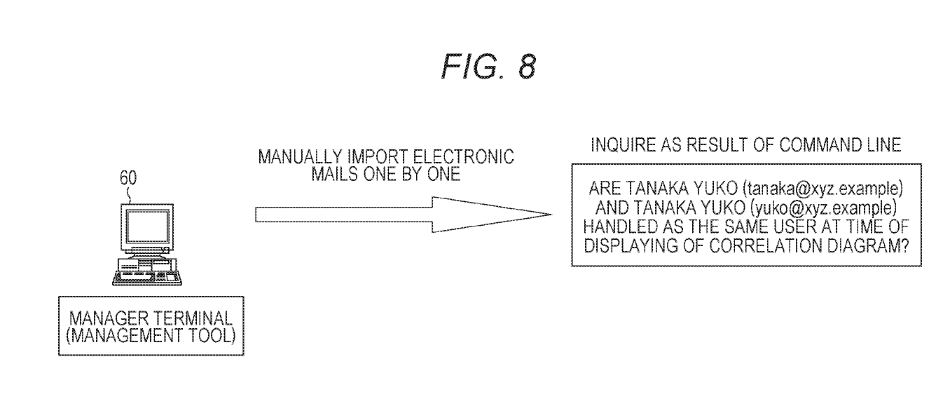

FIGS. 8 to 10 illustrate a method of performing an inquiry about whether to display a plurality of electronic mail addresses on the same terminal depending on a method of importing an electronic mail and a time at with the identical user determining process is performed.

(When Sending/Receiving Data is Imported for Each Piece)

FIG. 8 illustrates a state in which an inquiry about whether to display a plurality of electronic mail addresses on the same terminal is performed when the manager terminal 60 acquires sending/receiving data of electronic mails from the mailer of the PC terminal 40 and imports the sending/receiving data to the determination server 70 one by one.

In FIG. 8, the identical user determining process is performed whenever sending/receiving data of a new electronic mail is imported from the manager terminal 60. When the determination server 70 has determined that users of a plurality of new electronic mail addresses are the same user, an inquiry about whether to display a plurality of electronic mail addresses on the same terminal is returned immediately as a reply to the imported electronic mail (as a result of a command).

The user of the manager terminal 60 responses to the inquiry and the determination server 70 having received the response stores whether to gather and display the plurality of electronic mail addresses on one terminal at the time of displaying a correlation diagram.

(When Sending/Receiving Data is Gathered and Imported)

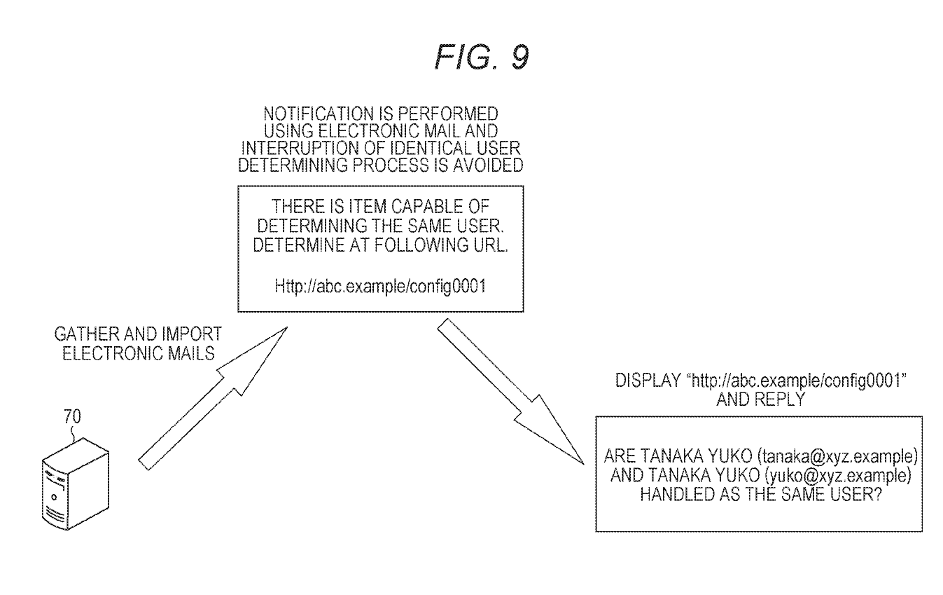

FIG. 9 illustrates a state in which an inquiry about whether to display a plurality of electronic mail addresses on the same terminal is performed when sending/receiving data of a plurality of electronic mails is gathered and acquired from the mail server 90 at a preset time or when the manager terminal 60 has instructed the determination server 70 to gather and import the sending/receiving data of the electronic mails.

In FIG. 9, the identical user determining process is performed when sending/receiving data of a plurality of electronic mails is newly gathered and acquired. At this time, the identical user determining process described with reference to FIGS. 6 and 7 is repeatedly performed using the gathered and acquired sending/receiving data. When it is determined during the repetition that the users of the plurality of electronic mail addresses are the same user, an electronic mail for an inquiry about whether to display a plurality of electronic mail addresses on the same terminal, which is associated with the electronic mail addresses, is sent to the manager terminal 60.

The user of the manager terminal 60 accesses the URL which is described in the electronic mail for the inquiry about whether to display a plurality of electronic mail addresses on the same terminal, which has been received from the determination server 70, and performs reply to the inquiry about whether to display a plurality of electronic mail addresses on the same terminal on a page of the access destination. The reply details are stored in the determination server 70.

In FIG. 9, the inquiry about whether to display a plurality of electronic mail addresses on the same terminal is sent in an electronic mail and then a reply is received through the URL described in the electronic mail. Accordingly, while the identical user determining process is repeatedly performed using the gathered and acquired sending/receiving data, it is possible to avoid interruption of the process due to the inquiry about whether to display a plurality of electronic mail addresses on the same terminal.

(When Identical User Determining Process is Performed in Response to Correlation Diagram Display Request)

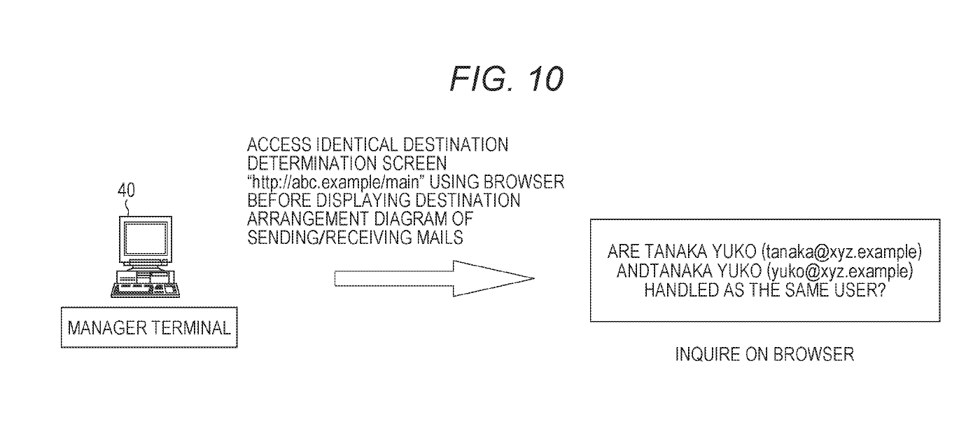

FIG. 10 illustrates a state in which an inquiry about whether to display a plurality of electronic mail addresses on the same terminal is performed when the determination server 70 having received the correlation diagram display request from the PC terminal 40 performs the identical user determining process immediately before the correlation diagram is prepared.

The determination server 70 acquires sending/receiving data of a plurality of electronic mails from the mail server 90 or the like in advance and stores the acquired sending/receiving data in the hard disk device 75. Immediately before a correlation diagram is prepared, the sending/receiving data is read and the identical user determining process illustrated in FIGS. 6 and 7 is repeatedly performed. When it has been determined during the repetition that users of the plurality of electronic mail addresses are the same user, an inquiry about whether to display a plurality of electronic mail addresses on the same terminal, which is associated with the electronic mail addresses, is performed on a browser. In FIG. 10, the inquiry about whether to display a plurality of electronic mail addresses on the same terminal is performed on the browser and a reply to the inquiry is received on the browser.

In FIG. 10, when the identical user determining process is completed for all the sending/receiving data stored in the hard disk device 75, a correlation diagram is prepared and data of the correlation diagram is transmitted to and displayed on the PC terminal 40. At that time, a plurality of electronic mail addresses which are instructed to be gathered on the same terminal in the inquiry about whether to display a plurality of electronic mail addresses on the same terminal are gathered and displayed on one terminal.

In the inquiry illustrated in FIGS. 8 to 10, when a user of an electronic mail address is registered in an address book of the hard disk device 75, the user is also displayed along with the electronic mail address. When a user is unclear and a name considered to be the user is described in the mail header or the text of the electronic mail, the name may be cited and displayed.

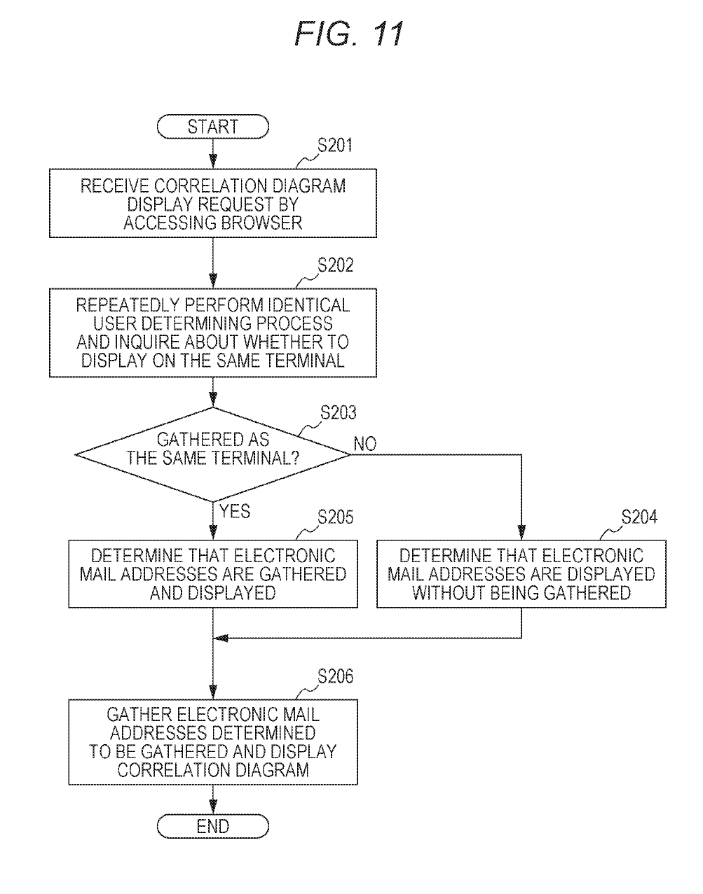

FIG. 11 illustrates a flow of a routine which is performed by the determination server 70 until a correlation diagram is displayed in FIG. 10. First, the determination server 70 repeatedly performs the identical user determining process on the basis of the stored sending/receiving data of electronic mails when a correlation diagram display request due to an access to a browser is received from a user via the PC terminal 40 (step S201), and receives an inquiry about whether to display a plurality of electronic mail addresses on the same terminal on a browser, which is associated with a plurality of electronic mail addresses, when it is determined that users of the plurality of electronic mail addresses are the same user (step S202).

It is determined that the electronic mail addresses which are instructed to be gathered and displayed on the same terminal in response to the inquiry about whether to display a plurality of electronic mail addresses on the same terminal (YES in step S203) are gathered and displayed on the same terminal at the time of preparing the correlation diagram (step S205) and the routine transitions to step S206.

It is determined that the electronic mail addresses which are instructed to be displayed without being gathered on the same terminal in response to the inquiry about whether to display a plurality of electronic mail addresses on the same terminal (NO in step S203) are displayed without being gathered on the same terminal at the time of preparing the correlation diagram (step S204) and the routine transitions to step S206.

Thereafter, the correlation diagram is prepared and displayed on the PC terminal 40. At this time, the electronic mail addresses which are determined to be gathered on the same terminal are gathered on the same terminal and displayed on the PC terminal 40 (step S206). Thereafter, the routine ends.

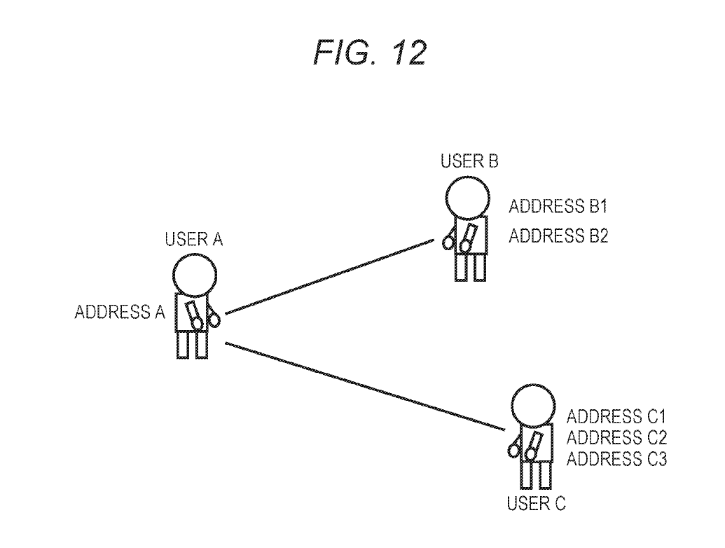

FIG. 12 illustrates an example of a correlation diagram which is displayed on the PC terminal 40. In the correlation diagram illustrated in FIG. 12, a correlation between users using six electronic mail addresses (Address A, Address B1, Address B2, Address C1, Address C2, and Address C3) is illustrated.

In the correlation diagram illustrated in FIG. 12, since another electronic mail address of which a user is common to the user of Address A is not present, Address A is displayed as a single terminal. Address B1 and Address B2 are used by the same user and thus are gathered and displayed as a single terminal. Address C1, Address C2, and Address C3 are used by the same user and thus are gathered and displayed as a single terminal.

When there is an electronic mail address of which user information is registered in an address book stored in the hard disk device 75 in the electronic mail addresses displayed as a single terminal (gathered), the user information is displayed together.

For example, when User C is registered as a user of Address C1 among Addresses C1 to C3 in the address book, User C as a user is displayed together in the single terminal on which Addresses C1, C2, and C3 are gathered. In FIG. 12, User A as a user of Address A, User B as a user of Addresses B1 and B2, and User C as a user of Addresses C1, C2, and C3 are displayed along with the corresponding terminals.

In this way, since the electronic mail addresses of the same user are gathered and displayed as a single terminal, it is possible to easily determine a correlation between the users.

Modified examples of one or more embodiments will be described below.

### MODIFIED EXAMPLE 1

In Modified Example 1, when information indicated by “Message-ID” included in a sending electronic mail and information indicated by “In-Reply-To” included in a reply electronic mail which is transmitted after the sending electronic mail and transmitted with a sending source of the sending electronic mail as a destination match each other (that is, when the first condition is satisfied) and a plurality of destinations are designated in the sending electronic mail, one destination thereof is selected by a user and it is determined that a user of the electronic mail address of the selected destination and a user of the electronic mail address as a sending source of the reply electronic mail are the same user.

When a plurality of destinations are designated in the sending electronic mail, there is a high likelihood that the users of the electronic mail addresses used as the destinations will be different users and thus the electronic mail address of which the user is the same as the user of the electronic mail address as a sending source of the reply electronic mail is selected by the user. A request for the selection can be performed, for example, at the same time as the inquiry about whether to display a plurality of electronic mail addresses on the same terminal.

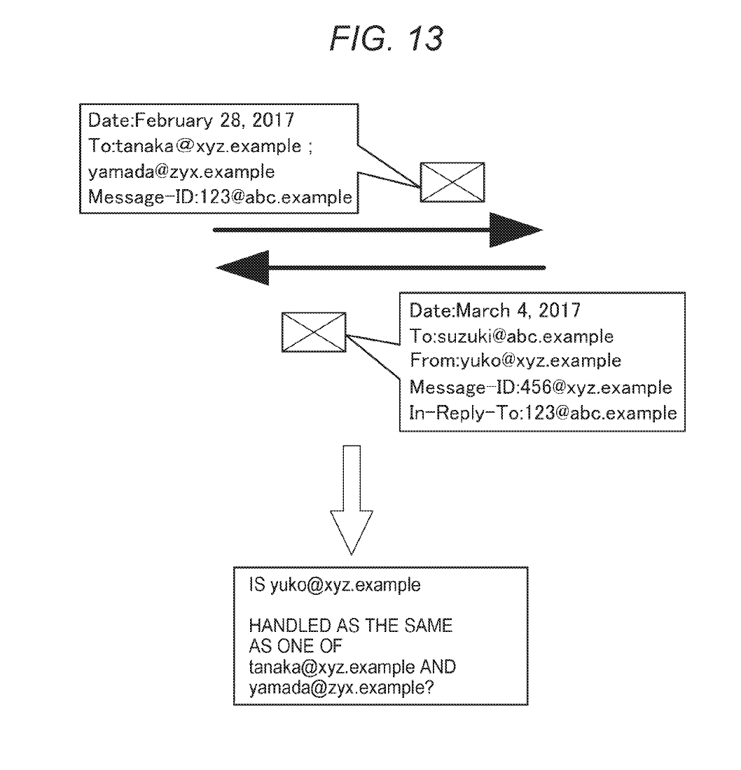

FIG. 13 illustrates a specific example of Modified Example 1. In FIG. 13, both of information indicated by “Message-ID” in a sending electronic mail and information indicated by “In-Reply-To” in a reply electronic mail transmitted after the sending electronic mail are “123@abc.example” and the first condition is satisfied. However, in the sending electronic mail, two electronic mail addresses of “tanaka@xyz.example” and “yamada@zyx.example” are designated as the destinations.

Therefore, the determination server 70 allows a user to select which of “tanaka@xyz.example” and “yamada@zyx.example” the electronic mail address has the same user as the user of “yuko@xyz.example” as the sending source of the reply electronic mail. Thereafter, it is determined that the user of the selected electronic mail address and the user of the electronic mail address as the sending source of the reply electronic mail are the same user.

### MODIFIED EXAMPLE 2

In Modified Example 2, when there are a plurality of reply electronic mails with a sending source of one sending electronic mail as a destination which is transmitted after the sending electronic mail and in which a value indicating specific identification information included in an electronic mail of a reply source matches an identifier specific to the sending electronic mail, there is a low likelihood that the users of the electronic mail addresses as the sending sources of the reply electronic mails will be the same user. Accordingly, in this way, when there are a plurality of reply electronic mails satisfying the first condition, it is not determined that the user of the electronic mail address as the sending source of one of the plurality of reply electronic mails and the user of the electronic mail address designated as the destination of the sending electronic mail are the same user.

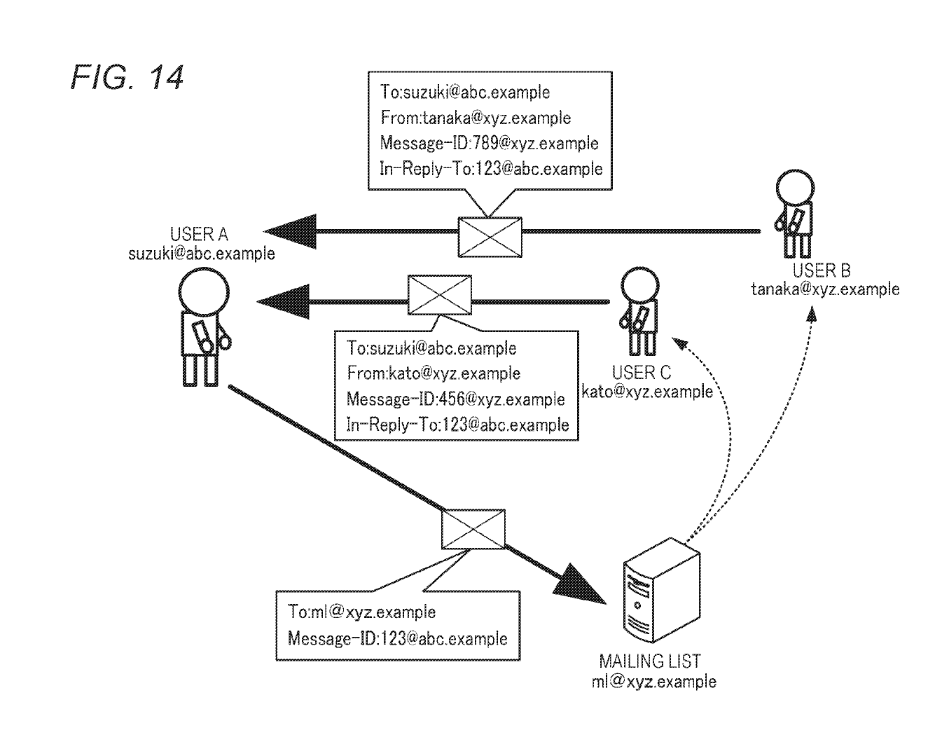

FIG. 14 illustrates a specific example of Modified Example 2. In FIG. 14, first, User A sends an electronic mail to a designated electronic mail address (“ml@xyz.example” in the drawing) in one mailing list, and the sending electronic mail is transmitted to all electronic mail addresses registered in the mailing list. Thereafter, User B and User C which are users of the electronic mail addresses as the destinations send reply mails to User A.

Information indicated by “Message-ID” in the sending electronic mail sent by User A and information indicated by “In-Reply-To” in the reply electronic mails sent by User B and User C after the sending electronic mail are common as “123@abc.example.” Since there are two reply electronic mails satisfying the first condition, the determination server 70 does not determine that the user of the electronic mail address as the destination of the sending electronic mail sent by User A and the users of the electronic mail addresses as the sending sources of the reply electronic mails sent by User B and User C are the same user.

In one or more embodiments, the first condition has been exemplified as the predetermined conditions for determining whether a user of an electronic mail address as a sending source of one reply electronic mail and a user of another electronic mail address are the same user, but a second condition which is another example of the predetermined conditions will be described below.

The second condition is that an electronic mail address indicating a sending source of one electronic mail is different from an electronic mail address designated as a reply destination. The determination server 70 determines that the users of the two electronic mail addresses are the same user when the second condition is satisfied.

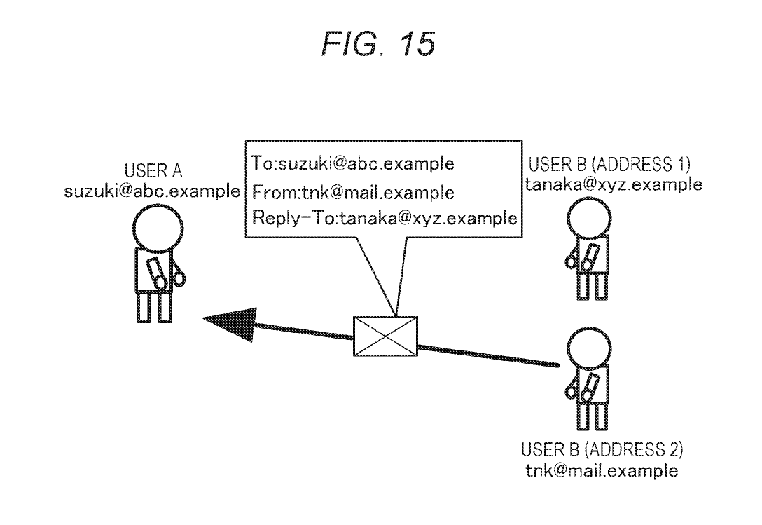

FIG. 15 illustrates an example in which it is determined that users of two electronic mail addresses are the same user on the basis of the second condition. In FIG. 15, User B sends an electronic mail to User A.

In the electronic mail, in the field of “From” of a mail header indicating a sending source, “tnk@mail.example” is designated. In the field of “Reply-To” indicating a reply destination, “tanaka@xyz.example” is designated.

Since the electronic mail addresses of “tnk@mail.example” and “tanaka@xyz.example” satisfy the second condition, the determination server 70 determines that the users of the two electronic mail addresses are the same user.

In FIG. 15, only one electronic mail address is designated in the field of “From” in the mail header, but when a plurality of electronic mail addresses are designated, the electronic mail address indicating a sending source is set to the electronic mail address included in the field of “Sender” in the mail header.

When the determination server 70 determines that the users of a plurality of electronic mail addresses are the same user using the second condition, it may be inquired whether to gather and display the electronic mail addresses as one terminal at the time of displaying of a correlation diagram similarly to one or more embodiments discussed above.

In one or more embodiments, a third condition which is another example of the predetermined conditions will be described below. The third condition is that a sentence feature extracted from the text of one sent/received electronic mail matches a sentence feature extracted from the text of another sent/received electronic mail. When the third condition is satisfied, the determination server 70 determines that a user of an electronic mail address as a sending source of the one electronic mail and a user of an electronic mail address as a sending source of another electronic mail are the same user.

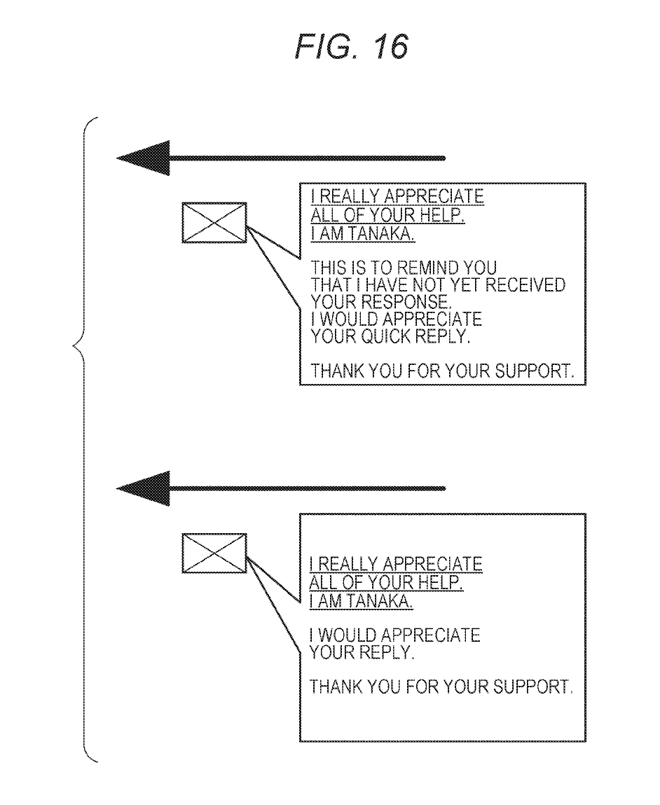

FIG. 16 illustrates an example in which it is determined that users of two electronic mail addresses are the same user using the third condition. In FIG. 16, the text of two electronic mails with different electronic mail addresses as sending sources is illustrated. In the two electronic mails, sentences of greeting in head paragraphs are common as “I really appreciate all of your help. I am Tanaka.”

Since a name of a sender is often included in a sentence of greeting in a head sentence, there is a high likelihood that senders of two electronic mails are common when sentence contents including the name are common. In FIG. 16, since the sentences in the head paragraphs are common, the third condition is satisfied. Accordingly, the determination server 70 determines that the users of the electronic mail addresses of the senders of the two electronic mails are the same user.

A feature to be extracted may include at least one of a part recognized as a typographical error, a style of writing symbols, Chinese characters, a Hiragana conversion pattern, a punctuation method, and a line feed or line blank inputting method in addition to a sentence of greeting and a signature. The number of features to be extracted is not limited one, but may be two or more.

When the determination server 70 determines that the users of a plurality of electronic mail addresses are the same user using the third condition, it may be inquired whether to gather and display the electronic mail addresses as one terminal at the time of displaying of a correlation diagram similarly to one or more embodiments discussed above.

In one or more embodiments, the first to third conditions have been exemplified as the predetermined conditions for determining whether a user of one electronic mail address and a user of another electronic mail address are the same user, but the predetermined conditions may be another condition. The first to third conditions may be used to perform the determination in combination.

An example in which the first to third conditions described in one or more embodiments are combined will be described below. When the first to third conditions are used in combination, first, it is checked whether the conditions are satisfied in the order of the first condition, the second condition, and the third condition. A plurality of electronic mail addresses which have been determined to have the same user due to satisfaction of the conditions are gathered and displayed as one terminal when a correlation diagram is prepared and displayed on the PC terminal 40.

It may be determined that users of a plurality of electronic mail addresses are the same user on the basis of the first to third conditions, but an electronic mail address with a user different that registered in an address book may be included therein. For example, when User A is registered as a user of Address A and User C is registered as a user of

Address C and it is determined that the users of Address A and Address B are common under the first condition and that the users of Address B and Address C are common under the second condition, it may not be determined which of User A and User C the user of Address B is.

In this case, priorities are set for the first to third conditions and determination based on satisfaction of the condition with a higher priority is prioritized. In the above-mentioned example, when the first condition has a priority higher than that of the third condition, the determination that the users of Address A and Address B are common is prioritized and it is determined that the user of Address B is User A. A user may be inquired about which determination to prioritize.

As in Modified Example 2, when there are a plurality of reply electronic mails satisfying the first condition, it is not determined whether a user of an electronic mail address as a sending source of one of the plurality of reply electronic mails and a user of an electronic mail address designated as a destination of the sending electronic mail are the same user, and it is determined that the users of the electronic mail addresses as the sending sources of the plurality of reply electronic mails are the same user under the second condition or the third condition, it may be determined that the users of the electronic mail addresses as the sending sources of the plurality of reply electronic mails and the user of the electronic mail address designated as the destination of the sending electronic mail are the same user.

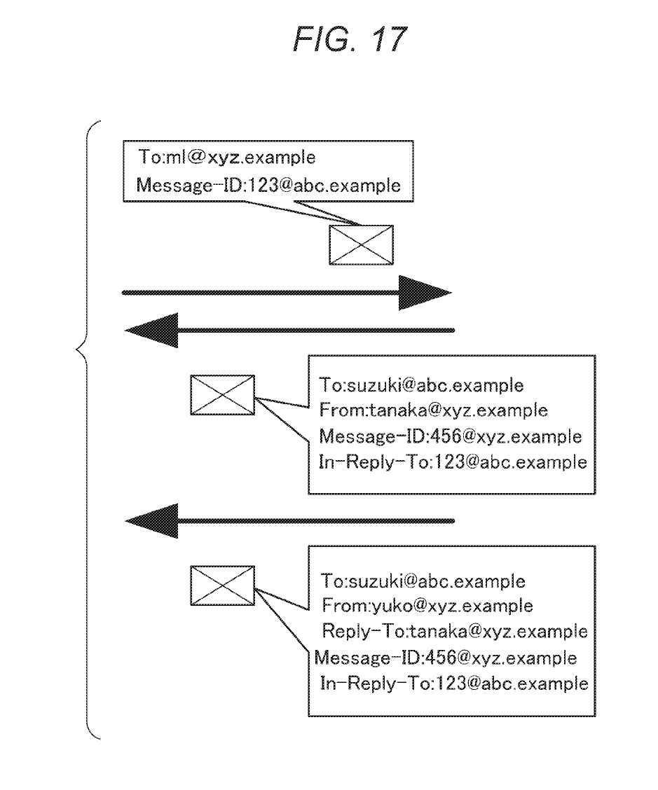

FIG. 17 illustrates an example in which there are a plurality of reply electronic mails satisfying the first condition and it is determined that the users of the reply electronic mails are the same user under the second condition as in Modified Example 2.

In FIG. 17, one sending electronic mail (of which a destination is “ml@xyz.example”) and two reply electronic mails sent after the sending electronic mail in response to the sending electronic mail are illustrated. Information indicated by “Message-ID” of the sending electronic mail and information indicated by “In-Reply-To” of the two reply electronic mails are common as “123@abc.example.” That is, in FIG. 17, there are two reply electronic mails satisfying the first condition in response to the sending electronic mail.

In one of the two reply electronic mails, “yuko@xyz.example” is designated in the field of “From” in the mail header indicating a sending source. “tanaka@xyz.example” is designated in the field of “Reply-To” in the mail header indicating a reply destination. Accordingly, since the electronic mail addresses of “yuko@xyz.example” and “tanaka@xyz.example” satisfy the second condition, it is determined that the users are the same.

In the other of the two reply electronic mails, “tanaka@xyz.example” is designated in the field of “From” in the mail header indicating a sending source. Accordingly, it is determined that the users of the electronic mail addresses as the sending sources of the two reply electronic mails are the same.

In this way, when there are a plurality of reply electronic mails satisfying the first condition in response to one sending electronic mail and it is determined that the users of the electronic mail addresses as the sending sources of the plurality of electronic mails are common under another condition, the determination server 70 determines that the user of the electronic mail address as a destination of the sending electronic mail and the users of the electronic mail addresses as the sending sources of the plurality of reply electronic mails are common.

In one or more embodiments of the present invention, description has been made on a case where all of the first to third conditions are combined, but the combination is not limited thereto and two conditions may be combined.

While embodiments of the present invention have been described above with reference to the drawings, the specific configuration is not limited to the embodiments and modifications or additions without departing from the gist of the present invention are included in the scope of the invention.

In one or more embodiments of the present invention, the determination server 70 and the manager terminal 60 are separate devices, but may be embodied as a single device.

In one or more embodiments of the present invention, when the first to third conditions are combined, it is checked whether the conditions are satisfied in the order of the first condition, the second condition, and the third condition, but the checking order is not limited thereto.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An electronic mail sender and recipient correlation determination system comprising:
a hardware processor that:
determines whether a first user of a first electronic mail address and a second user of a second electronic mail address are identical, wherein the first electronic mail address is designated as a destination of a sending electronic mail that has been sent and the second electronic mail address is designated as a sending source of a reply electronic mail that has been sent,
determines whether a value indicating identification information that is included in and specific to the sending electronic mail matches a value indicating specific identification information that is included in an electronic mail of a reply source of the reply electronic mail,
determines that the first user and the second user are identical when the value indicating identification information matches the value indicating specific identification information, wherein
the reply electronic email is sent, after the sending electronic mail, with a sending source of the sending electronic mail as a destination.

2. The electronic mail sender and recipient correlation determination system according to claim 1, wherein
the first electronic mail address is included in a “To” field of a mail header,
the second electronic mail address is included in a “From” field of the mail header,
the identification information is included in a “Message-ID” field of the mail header, and
the value indicating the specific identification information is included in a “In-Reply-To” field of the mail header.

3. The electronic mail sender and recipient correlation determination system according to claim 2, wherein when a plurality of electronic mail addresses is included in the “From” field, the second electronic mail address is set to be included in a “Sender” field of the mail header.

4. The electronic mail sender and recipient correlation determination system according to claim 1, wherein when the recognition has been performed and a plurality of destinations are designated in the sending electronic mail, the hardware processor:
causes a user to select one of the plurality of destinations, and
determines that a user of an electronic mail address of the selected destination and the second user are identical.

5. The electronic mail sender and recipient correlation determination system according to claim 1, wherein when there are a plurality of reply electronic mails with the sending source of the sending electronic mail as a destination and the values indicating specific identification information included in a sending electronic mail of the reply source matches an identifier specific to the sending electronic mail, the hardware processor determines that a user of the electronic mail address of a sending source of one of the plurality of reply electronic mails and a user of an electronic mail address that is designated as a destination of the sending electronic mail are different.

6. The electronic mail sender and recipient correlation determination system according to claim 5, wherein the hardware processor:
determines that users of two electronic mail addresses are identical when an electronic mail address of a sending source of one electronic mail and an electronic mail address designated as a reply destination are different, and
determines that users of electronic mail addresses of sending sources of the plurality of reply electronic mails and a user of an electronic mail address that is designated as a destination of the sending electronic mail are identical when the processor determines that the users of the electronic mail addresses of the sending sources of the plurality of reply electronic mails are identical.

7. An electronic mail sender and recipient correlation determination system comprising:
a hardware processor that determines that users of two electronic mail addresses are identical when a first electronic mail address indicating a sending source of a first electronic mail and a second electronic mail address designated as a reply destination of a second electronic mail are different.

8. The electronic mail sender and recipient correlation determination system according to claim 7, wherein
the first electronic mail address is included in a “From” field in a mail header, and
the second electronic mail address is included in a “Reply-To” field of the mail header.

9. The electronic mail sender and recipient correlation determination system according to claim 8, wherein when a plurality of electronic mail addresses are included in the “From” field, the first electronic mail address is included in a “Sender” field of the mail header.

10. An electronic mail sender and recipient correlation determination system comprising:
a hardware processor that:
determines whether a user of an electronic mail address of a sending source of a first electronic mail that has been sent and received is identical to a user of an electronic mail address of a sending source of a second electronic mail that has been sent and received,
determines whether a first sentence feature extracted from text of the first electronic mail matches a second sentence feature extracted from text of the second electronic mail, and
determines that the user of the electronic mail address of the sending source of the first electronic mail is identical to the user of the electronic mail address of the sending source of the second electronic mail when the first sentence feature matches the second sentence feature.

11. The electronic mail sender and recipient correlation determination system according to claim 10, wherein the first and second sentence features are at least one of a part recognized as a typographical error, a style of writing symbols, Chinese characters, a Hiragana conversion pattern, a punctuation method, and a line feed or line blank inputting method.

12. The electronic mail sender and recipient correlation determination system according to claim 1, wherein the hardware processor:
prepares and displays a correlation diagram with an electronic mail address as a terminal that is expressed by a line segment connecting a first terminal that corresponds to the electronic mail address as a sending source of a sent and received electronic mail and a second terminal that corresponds to an electronic mail address as a destination, and
gathers and displays a plurality of electronic mail addresses on the terminal, users that have been determined to be identical.

13. The electronic mail sender and recipient correlation determination system according to claim 12, further comprising:
a storage that stores the sent and received electronic mail, wherein
the hardware processor prepares the correlation diagram based on the electronic mails stored in the storage.

14. The electronic mail sender and recipient correlation determination system according to claim 12, wherein the hardware processor performs the determination when the hardware processor prepares and displays the correlation diagram.

15. The electronic mail sender and recipient correlation determination system according to claim 13, wherein the hardware processor performs the determination on an imported new electronic mail when the new electronic mail is imported to the storage.

16. The electronic mail sender and recipient correlation determination system according to claim 12, wherein the hardware processor:
transmits an inquiry about whether a plurality of electronic mail addresses where users have been determined to be identical are gathered and displayed on one of the first or second terminals, and
gathers and displays the plurality of electronic mail addresses, users that have been determined to be identical, on the terminal only when the hardware processor has been instructed to gather and display the electronic mail addresses.

17. The electronic mail sender and recipient correlation determination system according to claim 7, wherein the hardware processor:
prepares and displays a correlation diagram with an electronic mail address as a terminal that is expressed by a line segment connecting a first terminal corresponding to the electronic mail address as a sending source of a sent and received electronic mail and a second terminal that corresponds to an electronic mail address as a destination, and
gathers and displays a plurality of electronic mail addresses on the terminal, users that have been determined to be identical.

18. The electronic mail sender and recipient correlation determination system according to claim 10, wherein the hardware processor:
prepares and displays a correlation diagram with an electronic mail address as a terminal that is expressed by a line segment connecting a first terminal corresponding to the electronic mail address as a sending source of a sent and received electronic mail and a second terminal that corresponds to an electronic mail address as a destination, and
gathers and displays a plurality of electronic mail addresses on the terminal, users that have been determined to be identical.
